(19) United States
(12) Patent Application Publication
(10) Pub. No.: US 2018/0122369 A1
(43) Pub. Date: May 3, 2018

(54) INFORMATION PROCESSING SYSTEM, INFORMATION PROCESSING APPARATUS, AND INFORMATION PROCESSING METHOD

(71) Applicant: FUJITSU LIMITED, Kawasaki-shi (JP)

(72) Inventors: Kei TAIRA, Kita (JP); Takumi BABA, Kawasaki (JP); Takashi Imai, Atsugi (JP); Miwa Okabayashi, Sagamihara (JP); Tatsuro Matsumoto, Yokohama (JP)

(73) Assignee: FUJITSU LIMITED, Kawasaki-shi (JP)

(21) Appl. No.: 15/729,948

(22) Filed: Oct. 11, 2017

(30) Foreign Application Priority Data
Oct. 28, 2016 (JP) 2016-212049

(51) Int. Cl. G10L 15/18; G10L 15/22

(52) U.S. Cl. CPC G10L 15/1815; G10L 15/02; G10L 2015/223; G10L 15/22

(57) ABSTRACT

An information processing system includes a processor configured to: extract an intention of a user and context of utterance from the utterance of the user via a microphone, generate topic data which includes an execution situation of the intention based on the intention and the context, generate utterance content according to the execution situation of the generated topic data, and output the utterance content to the user via a speaker.

### CROSS-REFERENCE TO RELATED APPLICATION

This application is based upon and claims the benefit of priority of the prior Japanese Patent Application No. 2016-212049, filed on Oct. 28, 2016, the entire contents of which are incorporated herein by reference.

### FIELD

The embodiments discussed herein are related to an information processing system, an information processing apparatus, and an information processing method.

### BACKGROUND

A dialogue system which performs a dialogue with a user is known. The dialogue system realizes the dialogue with the user by, for example, giving an answer, which is registered in advance, with respect to utterance from the user or by performing utterance according to predetermined scenarios with respect to the user.

Japanese Laid-open Patent Publication No. 2001-188782 is an example of the related art.

However, in the related art, for example, it is difficult to perform a dialogue while introducing a new subject (topic) as a dialogue performed between people. Therefore, in a case where the dialogue system is used for a certain period, answers from the dialogue system are patterned, and thus the user may get tired of the dialogue.

### SUMMARY

According to an aspect of the embodiments, an information processing system includes a processor configured to: extract an intention of a user and context of utterance from the utterance of the user via a microphone, generate topic data which includes an execution situation of the intention based on the intention and the context, generate utterance content according to the execution situation of the generated topic data, and output the utterance content to the user via a speaker.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of dialogue in a dialogue system according to a first embodiment (1/2);

FIG. 2 is a diagram illustrating an example of the dialogue in the dialogue system according to the first embodiment (2/2);

FIG. 3 is a diagram illustrating an example of a hardware configuration of a computer which realizes the dialogue system according to the first embodiment;

FIG. 4 is a diagram illustrating an example of a functional configuration of the dialogue system according to the first embodiment;

FIG. 5 is a diagram illustrating an example of a detailed configuration of topic data;

FIG. 6 is a flowchart illustrating an example of an entire process in a case of dialogue according to the first embodiment;

FIG. 7 is a flowchart illustrating an example of a new topic generation process according to the first embodiment;

FIG. 8 is a flowchart illustrating an example of a topic selection process (in a case of dialogue) according to the first embodiment;

FIG. 9 is a flowchart illustrating an example of a topic priority setting process according to the first embodiment;

FIG. 10 is a flowchart illustrating an example of an utterance content generation and output process according to the first embodiment;

FIG. 11 is a diagram illustrating an example of utterance in a case of an idle talk in a dialogue system according to a second embodiment;

FIG. 12 is a diagram illustrating an example of a functional configuration of a dialogue system according to the second embodiment;

FIG. 13 is a flowchart illustrating an example of an entire process in the case of the idle talk according to the second embodiment;

FIG. 14 is a flowchart illustrating an example of a topic selection process (in the case of the idle talk) according to the second embodiment;

FIG. 15 is a diagram illustrating an example of a case where a topic is updated through notification from an application in a dialogue system according to a third embodiment;

FIG. 16 is a diagram illustrating an example of a functional configuration of the dialogue system according to the third embodiment;

FIG. 17 is a flowchart illustrating an example of an entire process in a case of dialogue according to the third embodiment; and

FIG. 18 is a flowchart illustrating an example of an application cooperation process according to the third embodiment.

### DESCRIPTION OF EMBODIMENTS

Hereinafter, embodiments of the present disclosure will be described with reference to the accompanying drawings.

### First Embodiment

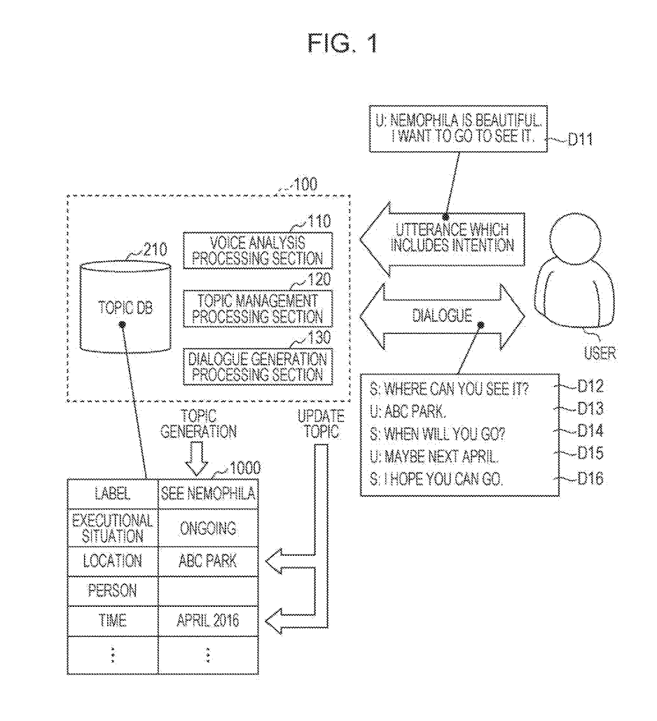

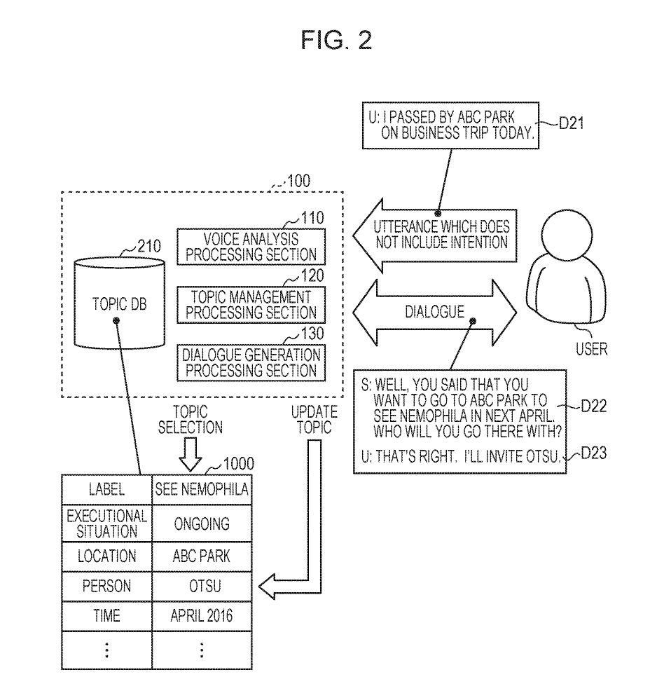

First, a dialogue in a dialogue system 100 according to the embodiment will be described with reference to FIGS. 1 and 2. FIGS. 1 and 2 are diagrams illustrating an example of the dialogue in the dialogue system 100 according to the first embodiment.

The dialogue system 100 according to the embodiment is an information processing apparatus (computer) or an information processing system which performs a dialogue with a user by uttering an answer with respect to utterance content according to the utterance from the user. It is possible to use, for example, a smart phone, a tablet terminal, a mobile phone, a personal computer (PC), an embedded type computer, which is installed in a robot, or the like as the dialogue system 100 according to the embodiment.

As illustrated in FIGS. 1 and 2, the dialogue system 100 according to the embodiment includes a voice analysis processing section 110 that extracts intention or context from the utterance of the user, and a topic management processing section 120 that generates or selects a topic (subject) from the intention or the context. In addition, the dialogue system 100 according to the embodiment includes a dialogue generation processing section 130 that generates utterance content based on the selected topic, and a topic DB (database) 210 that stores data (topic data) 1000 indicative of the topic.

Here, the utterance of the user includes utterance which includes an intention and utterance which does not include an intention. The intention indicates content, which is desired or scheduled to be performed by the user in the future, or content which is recognized to be desired to perform by the user in the future. The intention includes, for example, wishes (for example, “I want to go to the ABC park” and the like) such as “I want to do XX” and “Shall I do XX”, and duties (for example, “I have to clean the room” and the like) such as “I have to do XX” and “It is desired to do XX”.

In addition, the context indicates a location, a person, time, an hour, completion of an operation, and the like which are included in the utterance of the user.

As illustrated in FIG. 1, for example, in a case where the user performs utterance D11 “Nemophila is beautiful. I want to go to see it” or the like, the dialogue system 100 according to the embodiment extracts an intention (“I want to see nemophila.”) included in the utterance D11 by the voice analysis processing section 110. Subsequently, the dialogue system 100 according to the embodiment generates topic data 1000, which includes a label “see nemophila” corresponding to the extracted intention and an execution situation “ongoing” of content indicated by the label, by the topic management processing section 120, and stores the generated label in the topic DB 210.

Here, in a case of information (for example, the intention is “want to see nemophila”) which directly expresses the intention, the label becomes “see nemophila”. In addition, the execution situation indicates a situation of execution of the content (for example, “see nemophila”) indicated by the label. The execution situation includes, for example, “ongoing” which indicates that content indicated by the label is not executed yet, “execution completion” which indicates that content indicated by the label is completely executed, “non-execution” which indicates that content indicated by the label is not executed (or it is not possible to execute the content), and the like.

Meanwhile, the topic data 1000 includes information, such as a location and time in which the content indicated by the label is executed and a person who executes the content indicated by the label together with the user, in addition to the label and the execution situation. Hereinafter, in data items included in the topic data 1000, data items which store information, such as the execution situation, the location, the time, and the person, are referred to as “slots”. Meanwhile, a detailed configuration of the topic data 1000 will be described later.

Furthermore, the dialogue system 100 according to the embodiment generates utterance content in order to embed slots which indicate the location, the person, the time, and the like and utters (outputs) the utterance content to the user by the dialogue generation processing section 130. Thereafter, the dialogue system 100 according to the embodiment updates the topic data 1000 based on answer utterance with respect to utterance to the user by the topic management processing section 120.

That is, for example, the dialogue system 100 according to the embodiment performs utterance D12 by generating utterance content “Where can you see it?” in order to embed a slot indicative of the location, and outputting the utterance content. Furthermore, for example, in a case where there is answer utterance D13 “ABC park” from the user, the dialogue system 100 according to the embodiment updates the slot indicative of the location of the topic data 1000 to “ABC park”.

Similarly, the dialogue system 100 according to the embodiment performs utterance D14 by generating utterance content “When will you go?” in order to embed a slot indicative of the time by the dialogue generation processing section 130, and outputting the utterance content. Furthermore, for example, in a case where there is answer utterance D15 “Maybe in next April” from the user, the dialogue system 100 according to the embodiment updates the slot indicative of time of the topic data 1000 to “April, 2016” indicative of “next April”.

As described above, in a case where the user performs utterance which includes intention, the dialogue system 100 according to the embodiment generates the topic data 1000 based on the intention, and manages the topic data 1000 in the topic DB 210. In addition, in a case where the topic data 1000 is generated, the dialogue system 100 according to the embodiment performs utterance with respect to the user in order to embed the slots (the location, the person, the time, and the like) of the topic data 1000.

Meanwhile, in the example illustrated in FIG. 1, a case in which the topic data 1000 of a label corresponding to the intention included in the utterance of the user is not stored in the topic DB 210 (that is, a case where the user performs new utterance which includes intention) is described. In a case where the topic data 1000 of the label corresponding to the intention included in the utterance of the user is stored in the topic DB 210 in advance, the topic data 1000 according to context extracted based on the utterance is selected from the topic DB 210, similarly to an example illustrated in FIG. 2 which will be described later.

As illustrated in FIG. 2, for example, in a case where the user performs utterance (utterance which does not include intention) D21 such as “I passed by the ABC park on a business trip today.”, the dialogue system 100 according to the embodiment extracts context of the utterance D21 by the voice analysis processing section 110. Subsequently, the dialogue system 100 according to the embodiment selects the topic data 1000 according to the extracted context from the topic DB 210 by the topic management processing section 120.

Meanwhile, for example, in a case where a location “ABC park” is extracted as the context, the topic data 1000 according to the context indicates topic data 1000 in which “ABC park” is set to the slot indicative of the location.

Furthermore, the dialogue system 100 according to the embodiment generates utterance content in order to embed an empty slot of the selected topic data 1000, utterance content in order to update the execution situation, and the like by the dialogue generation processing section 130, and utters (outputs) the utterance content with respect to the user. Thereafter, the dialogue system 100 according to the embodiment updates the topic data 1000 based on the answer utterance with respect to the utterance to the user by the topic management processing section 120. Meanwhile, the empty slot indicates a slot to which information is not set (or a slot to which blank or a NULL value is set).

That is, the dialogue system 100 according to the embodiment generates, for example, utterance content “Well, you said that you want to go to the ABC park to see nemophila in next April. Who will you go there with?” based on the selected topic data 1000. Furthermore, the dialogue system 100 according to the embodiment performs utterance D22 by outputting the utterance content. Thereafter, for example, in a case where there is answer utterance D23 “That's right. I'll invite Otsu.” from the user, the dialogue system 100 according to the embodiment updates the slot indicative of the person of the topic data 1000 to “Otsu”.

As described above, in a case where the user performs the utterance which does not include intention, the dialogue system 100 according to the embodiment selects the topic data 1000 according to the context, which is extracted from the utterance, from the topic DB 210. Furthermore, the dialogue system 100 according to the embodiment performs utterance in order to update the slot, the execution situation, and the like of the selected topic data 1000 with respect to the user.

As described above, in the dialogue system 100 according to the embodiment, a new subject (topic) is established based on the utterance, which includes intention, such as “I want to do XX” or “Shall I do XX”, and the topic data 1000 which indicates the topic is managed by the topic DB 210. Furthermore, the dialogue system 100 according to the embodiment selects past topic data 1000 based on the context of the utterance performed by the user, and performs utterance in order to update the slot, the execution situation, and the like of the topic data 1000 with respect to the user.

Therefore, in a case where the user performs various utterances which include intention, the dialogue system 100 according to the embodiment can perform a dialogue with the user for various topics (subjects). Therefore, the user can continue various dialogues for a long time without getting tired.

In addition, the dialogue system 100 according to the embodiment performs a dialogue with the user for a topic (subject) according to the context extracted from the utterance of the user, and thus, for example, it is possible to remind the user of past intention (for example, “want to go to XX”).

Meanwhile, the configuration of the dialogue system 100 illustrated in FIGS. 1 and 2 is an example, and another configuration may be provided. For example, in a case where the dialogue system 100 is realized by one information processing apparatus, the voice analysis processing section 110, the topic management processing section 120, the dialogue generation processing section 130, and the topic DB 210 may be included in the one information processing apparatus. In contrast, for example, in a case where the dialogue system 100 is realized by a plurality of information processing apparatuses, the voice analysis processing section 110, the topic management processing section 120, the dialogue generation processing section 130, and the topic DB 210 may be included in the same or different information processing apparatuses, respectively.

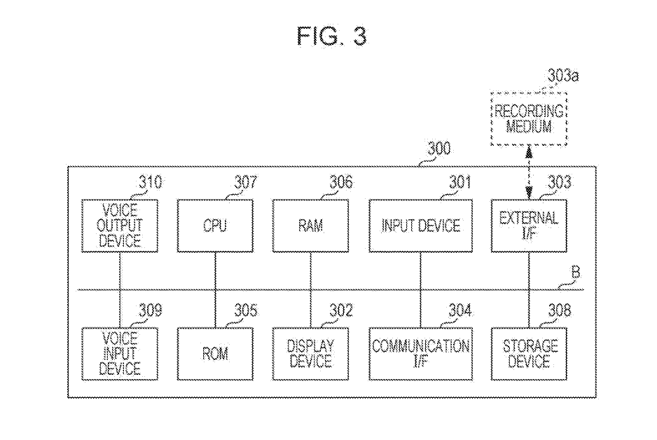

Subsequently, a hardware configuration of a computer 300 which realizes the dialogue system 100 according to the embodiment will be described with reference to FIG. 3. FIG. 3 is a diagram illustrating an example of the hardware configuration of the computer 300 which realizes the dialogue system 100 according to the first embodiment. The dialogue system 100 according to the embodiment is realized by, for example, one or more computers 300.

As illustrated in FIG. 3, the computer 300 includes an input device 301, a display device 302, an external I/F 303, a communication I/F 304, and a read only memory (ROM) 305. In addition, the computer 300 includes a random access memory (RAM) 306, a central processing unit (CPU) 307, a storage device 308, a voice input device 309, and a voice output device 310. The respective hardwares are connected to each other through a bus B.

The input device 301 includes, for example, various buttons and touch panels, a keyboard, a mouse, and the like, and are used to input various operational signals to the computer 300. The display device 302 includes, for example, a display and the like, and displays various processing results acquired by the computer 300. Meanwhile, the computer 300 may not include at least one of the input device 301 and the display device 302.

The external I/F 303 is an interface between the computer and an external device. The external device includes a recording medium 303a and the like. The computer 300 can perform reading/writing on the recording medium 303a through the external I/F 303.

Meanwhile, the recording medium 303a includes, for example, an SD memory card, a USB memory, a compact disk (CD), a digital versatile disk (DVD), and the like.

The communication I/F 304 is an interface for connecting the computer 300 to a network. The computer 300 can communicate with another computer 300 and the like through the communication I/F 304.

The ROM 305 is a non-volatile semiconductor memory that can maintain data even in a case where power is turned off. The RAM 306 is a volatile semiconductor memory that temporarily maintains a program and data. The CPU 307 is a processor reads, for example, a program and data from the storage device 308, the ROM 305, and the like on the RAM 306, and executes various processes.

The storage device 308 includes, for example, a hard disk drive (HDD), a solid-state drive (SSD), and the like, and is a non-volatile memory that stores a program and data. The program and the data, which are stored in the storage device 308, include, for example, a program which realizes the embodiment, an operating system (OS) which is a basic software, various applications which operate on the OS, and the like.

The voice input device 309 includes, for example, a microphone and the like, and inputs voice such as utterance from the user. The voice output device 310 includes, for example, a speaker and the like, and outputs voice such as utterance from the dialogue system 100.

In the dialogue system 100 according to the embodiment, various processes, which will be described later, are realized by the computer 300 illustrated in FIG. 3.

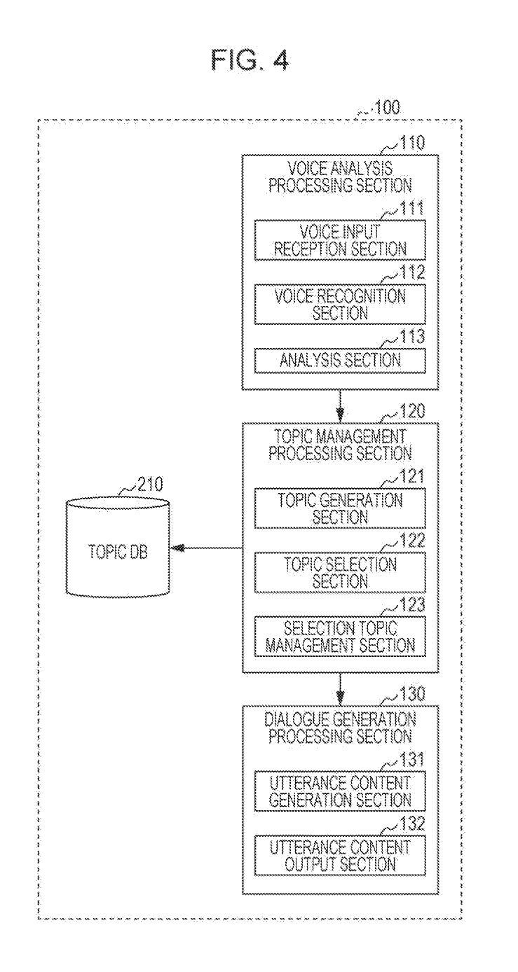

Subsequently, a functional configuration of the dialogue system 100 according to the embodiment will be described with reference to FIG. 4. FIG. 4 is a diagram illustrating an example of the functional configuration of the dialogue system 100 according to the first embodiment.

As illustrated in FIG. 4, the voice analysis processing section 110 of the dialogue system 100 includes a voice input reception section 111, a voice recognition section 112, and an analysis section 113. The voice analysis processing section 110 is realized by a process. One or more programs, which are installed in the dialogue system 100, cause the CPU 307 to execute the process.

The voice input reception section 111 receives input of utterance (voice) from the user. The voice recognition section 112 performs voice recognition on the voice, the input of which is received by the voice input reception section 111, and converts the voice into, for example, text. The analysis section 113 analyzes a result of voice recognition performed by the voice recognition section 112, and extracts intention and context.

That is, the analysis section 113 extracts the intention (for example, “want to do XX”, “XX is demanded”, and the like) and the context (for example, the location, the person, the time, and the like) with respect to, for example, text, which is acquired in such a way that the voice is converted, by performing a natural language process such as morpheme analysis and semantic analysis.

The topic management processing section 120 of the dialogue system 100 includes a topic generation section 121, a topic selection section 122, and a selection topic management section 123. The topic management processing section 120 is realized by a process. One or more programs, which are installed in the dialogue system 100, cause the CPU 307 to execute the process.

The topic generation section 121 generates the topic data 1000 based on the intention extracted by the analysis section 113. That is, the topic generation section 121 generates the topic data 1000 which includes a label corresponding to the intention extracted by the analysis section 113 and the execution situation “ongoing”. Meanwhile, in a case where the topic data 1000, which is generated based on the same intention as the intention extracted by the analysis section 113, is stored in the topic DB 210 in advance, the topic generation section 121 does not generate the topic data 1000.

Furthermore, the topic generation section 121 stores the generated topic data 1000 in the topic DB 210.

The topic selection section 122 selects the topic data 1000, which is generated by the topic generation section 121, and the topic data 1000, which corresponds to the context extracted by the analysis section 113, in the topic data 1000 which is stored in the topic DB 210.

That is, in a case where the topic data 1000 is generated from the utterance of the user, the topic selection section 122 selects the generated topic data 1000. In contrast, in a case where the topic data 1000 is not generated from the utterance of the user, the topic selection section 122 selects the topic data 1000 according to the context extracted based on the utterance in the topic data 1000 which is stored in the topic DB 210.

Hereinafter, the topic data 1000, which is selected by the topic selection section 122, is expressed as “selection topic data 1000”.

The selection topic management section 123 manages the topic data 1000 (selection topic data 1000) which is selected by the topic selection section 122. That is, the selection topic management section 123 manages the selection topic data 1000 by maintaining, for example, identification information (topic ID which will be described later), which identifies the selection topic data 1000, in a prescribed storage area. In addition, for example, in a case where a prescribed hour elapses without performing a dialogue with the user, the selection topic management section 123 deletes the identification information of the selection topic data 1000 from the prescribed storage area.

In addition, the selection topic management section 123 updates the selection topic data 1000 according to the answer utterance from the user or the like.

That is, the selection topic management section 123 updates the selection topic data 1000 by setting information (for example, the location, the person, the time, and the like) to the empty slot of the selection topic data 1000 according to the utterance of the user or the like. In addition, the selection topic management section 123 updates information of the slot of the selection topic data 1000 (for example, updates the execution situation from “ongoing” to “execution completion”) according to the utterance of the user or the like.

The dialogue generation processing section 130 of the dialogue system 100 includes an utterance content generation section 131 and an utterance content output section 132. The dialogue generation processing section 130 is realized by a process. One or more programs, which are installed in the dialogue system 100, cause the CPU 307 to execute the process.

The utterance content generation section 131 generates the utterance content based on the selection topic data 1000 which is selected by the topic selection section 122. That is, the utterance content generation section 131 generates, for example, utterance content in order to embed the empty slot of the selection topic data 1000.

The utterance content output section 132 outputs the utterance content, which is generated by the utterance content generation section 131, by voice. In a case where the utterance content is output by the utterance content output section 132, the dialogue system 100 can perform utterance with respect to the user. Meanwhile, utterance content output section 132 is not limited to a case where the utterance content is output by voice, and may display (output), for example, text which indicates the utterance content.

The topic DB 210 of the dialogue system 100 stores the topic data 1000. The topic DB 210 can be realized using, for example, storage device 308. The topic DB 210 may be realized using, for example, a storage device, which is connected to the dialogue system 100 through the network, or the like.

Meanwhile, hereinafter, in a case where a plurality of topic data 1000, which are stored in the topic DB 210, are classified, the topic data 1000 are expressed as “topic data 1000-1”, “topic data 1000-2”, “topic data 1000-3”, and the like.

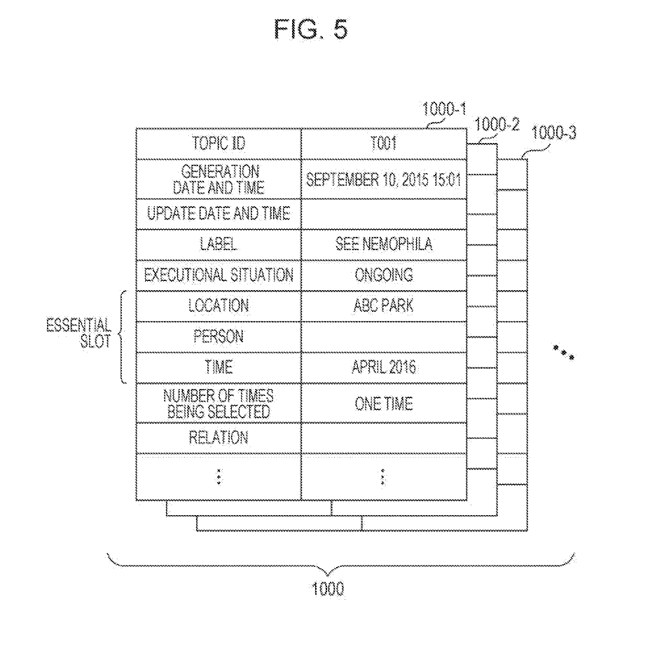

Here, details of the topic data 1000, which is stored in the topic DB 210, will be described with reference to FIG. 5. FIG. 5 is a diagram illustrating an example of a detailed configuration of the topic data 1000.

As illustrated in FIG. 5, for example, one or more topic data 1000, such as topic data 1000-1, topic data 1000-2, and topic data 1000-3, are stored in the topic DB 210.

The topic data 1000 includes a topic ID, a generation date and time, an update date and time, a label, an execution situation, a location, a person, a time, the number of times being selected, and a relation as data items. Meanwhile, as described above, in the data items, for example, data items, such as the execution situation, the location, the person, and the time are also referred to as the “slots”. In addition, in addition thereto, the data item, such as the relation, may be referred to as the “slot”. Meanwhile, in the slots, a slot indicative of the location, a slot indicative of the person, and a slot indicative of the time are specifically expressed as “indispensable slots”.

The topic ID is the identification information which identifies the topic data 1000. The generation date and time is a date and time in which the topic data 1000 is generated. The update date and time is a date and time in which the topic data 1000 is updated (that is, at least one data item of the topic data 1000 is updated).

The label is information which directly expresses intention included in the utterance of the user. The execution situation is a situation in which the content indicated by the label is executed. The execution situation includes, for example, “ongoing” which indicates that the content indicated by the label is not completely executed yet, “execution completion” which indicates that the content indicated by the label is completely executed, “non-execution” which indicates that the content indicated by the label is not executed, and the like.

The location is information of a location in which the content indicated by the label is executed. The person is information of a person who executes the content indicated by the label together with the user. The time is information of time in which the content indicated by the label is executed.

The number of times being selected is information of the number of times in which the topic data 1000 is selected by the topic selection section 122. The relation is various accompanying information related to the topic data 1000. Meanwhile, the topic data 1000 may include, for example, a data item “frequency” in which information of frequency, in which the topic data 1000 is selected by the topic selection section 122, is set.

As described above, the topic data 1000, which is stored in the topic DB 210, includes the data items (slots) such as the label, the execution situation, the location, the person, and the time. Therefore, the dialogue system 100 according to the embodiment can manage the execution situation of the subject (topic) of the dialogue with the user, the location in which the dialogue is performed, the person, the time, and the like.

Meanwhile, in the embodiment, the topic data 1000, which are independent from each other, are described. However, the topic data 1000 may be associated with each other. For example, topic data 1000 of a label “go on an overseas trip” and topic data 1000 of a label “go on an America trip” may be stored in the topic DB 210 such that the topic data 1000 of the label “go on an overseas trip” and topic data 1000 of the label “go on an America trip” has a relationship of a parent and child. Therefore, it is possible to manage a relevant subject (topic) in the topic DB 210 through association.

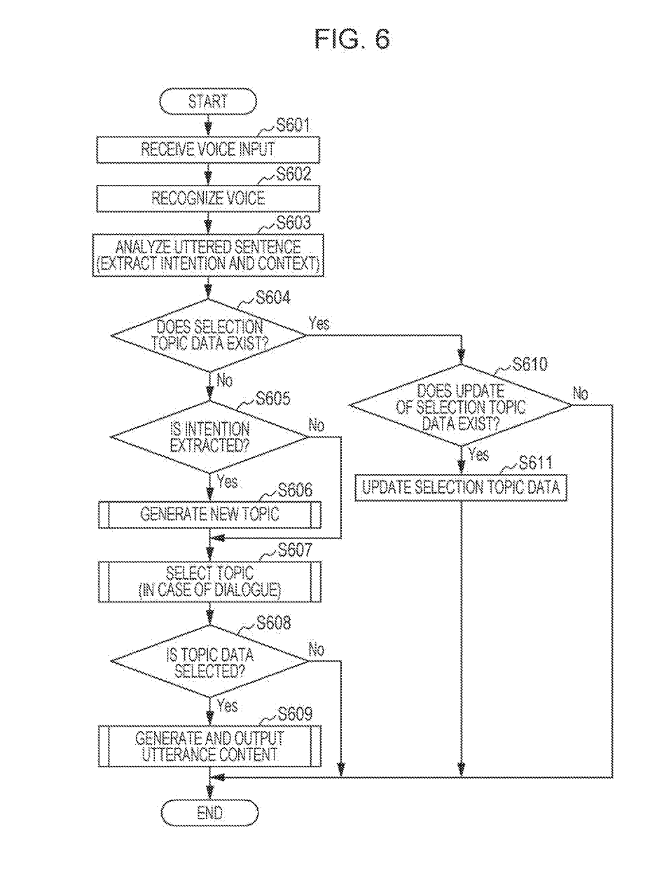

Subsequently, details of a process of the dialogue system 100 according to the embodiment will be described. Hereinafter, an entire process of the dialogue system 100 according to the embodiment in a case of dialogue will be described with reference to FIG. 6. FIG. 6 is a flowchart illustrating an example of the entire process in the case of the dialogue according to the first embodiment. The entire process in the case of the dialogue illustrated in FIG. 6 is performed, for example, whenever the utterance of the user(voice) is input.

First, the voice input reception section 111 of the voice analysis processing section 110 receives input of utterance (voice) from the user (step S601).

Subsequently, the voice recognition section 112 of the voice analysis processing section 110 performs voice recognition of voice, the input of which is received by the voice input reception section 111 (step S602). That is, the voice recognition section 112 converts voice, the input of which is received by the voice input reception section 111, into, for example, text using a voice recognition technology.

Subsequently, the analysis section 113 of the voice analysis processing section 110 analyzes a result of the voice recognition performed by the voice recognition section 112, and extracts intention and context (step S603). That is, analysis section 113 extracts the intention and the context by performing various natural language processes with respect to, for example, the text which is acquired by converting the voice.

For example, it is assumed that the text, which is acquired by converting the voice, is “I want to go to the ABC park with Otsu tomorrow”. In this case, the intention, which is extracted by the analysis section 113, is “I want to go to the ABC park”. In addition, the context, which is extracted by the analysis section 113, includes “tomorrow” indicative of the time, “Otsu” indicative of the person, “ABC park” indicative of the location, and “go” indicative of an action.

In addition, for example, it is assumed that the text, which is acquired by converting the voice, is “I went to the ABC park with Otsu yesterday”. In this case, the intention is not extracted by the analysis section 113 (that is, the utterance of the user does not include intention). In contrast, the context, which is extracted by the analysis section 113, includes “yesterday” indicative of the time, “Otsu” indicative of the person, “ABC park” indicative of the location, and “go” indicative of the action. Furthermore, here, the analysis section 113 extracts completion of action based on “went”.

Subsequently, the selection topic management section 123 of the topic management processing section 120 determines whether or not selection topic data 1000 exists (step S604). That is, the selection topic management section 123 determines, for example, whether or not the topic ID of the selection topic data 1000 is stored in the prescribed storage area.

In a case where it is determined that the selection topic data 1000 does not exist in step S604, the topic generation section 121 of the topic management processing section 120 determines whether or not intention is extracted by the analysis section 113 (step S605).

In a case where it is determined that the intention is extracted in step S605, the topic generation section 121 of the topic management processing section 120 performs a new topic generation process (step S606).

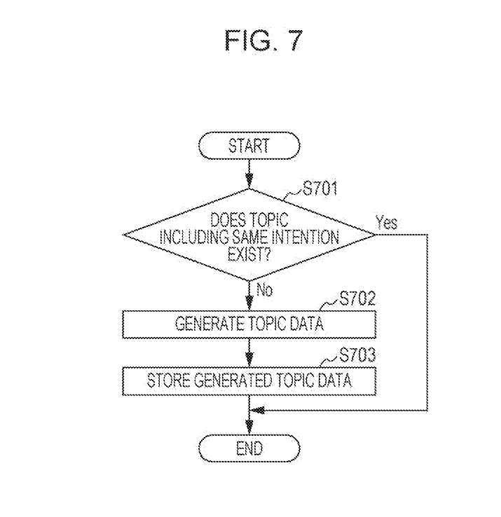

Here, details of the new topic generation process will be described with reference to FIG. 7. FIG. 7 is a flowchart illustrating an example of the new topic generation process according to the first embodiment.

First, the topic generation section 121 determines whether or not topic data 1000, which is generated based on the same intention as the intention extracted by the analysis section 113, is stored in the topic DB 210 (step S701).

That is, for example, it is assumed that the intention extracted by the analysis section 113 is “want to go to the ABC park”. In this case, the topic generation section 121 determines whether or not the topic data 1000, which includes the label “go to the ABC park” corresponding to the intention, is stored in the topic DB 210.

Here, the label corresponding to the intention is acquired by, for example, making a verb included in the intention be the infinitive (basic form). For example, in a case in which the intentions are “want to go to the ABC park”, “have to clean”, and the like, the labels may be “go to the ABC park” and “clean”, and the like, respectively.

In a case where the topic data 1000, which is generated based on the same intention, is not stored in the topic DB 210 in step S701, the topic generation section 121 generates the topic data 1000 (step S702).

That is, the topic generation section 121 generates the topic data 1000, which includes a label corresponding to the intention extracted by the analysis section 113, and the execution situation “ongoing”. Here, the topic generation section 121 sets the context, which is extracted by the analysis section 113, to a slot corresponding to the context. For example, in a case where the utterance of the user is “I want to go to the ABC park tomorrow” and the like, the topic generation section 121 sets the slot indicative of the time to date of “tomorrow”. Similarly, for example, in a case where the utterance of the user includes “I want to go to the ABC park with Otsu tomorrow” and the like, the topic generation section 121 sets the slot indicative of the time to date “tomorrow” and sets the slot indicative of the person to “Otsu”.

Furthermore, here, the topic generation section 121 sets the data item indicative of the topic ID to the identification information which identifies the topic data 1000, and sets the data item indicative of the generation date and time to a date and time in which the topic data 1000 is generated.

Meanwhile, the topic generation section 121 may set, for example, the slots indicative of the location, the person, the time, and the like to the empty slots.

Subsequently, the topic generation section 121 stores the generated topic data 1000 in the topic DB 210 (step S703). Therefore, the topic data 1000 of a new topic is stored in the topic DB 210. Meanwhile, in a case where the topic data 1000 is generated, the topic generation section 121 updates, for example, a flag (new topic generation flag) which indicates that the topic data 1000 is generated, to “1”.

In contrast, in a case where the topic data 1000, which is generated based on the same intention, is stored in the topic DB 210 in step S701, the topic generation section 121 ends the process. In this case, the topic data 1000 is not generated.

Returning to FIG. 6. In a case where it is determined that the intention is not extracted in step S605 or subsequent to step S606, the topic selection section 122 of the topic management processing section 120 performs a topic selection process (in a case of dialogue) (step S607). That is, the topic selection section 122 selects the topic data 1000, which is generated in step S606, or the topic data 1000, which corresponds to the context extracted by the analysis section 113, from the topic data 1000 stored in the topic DB 210.

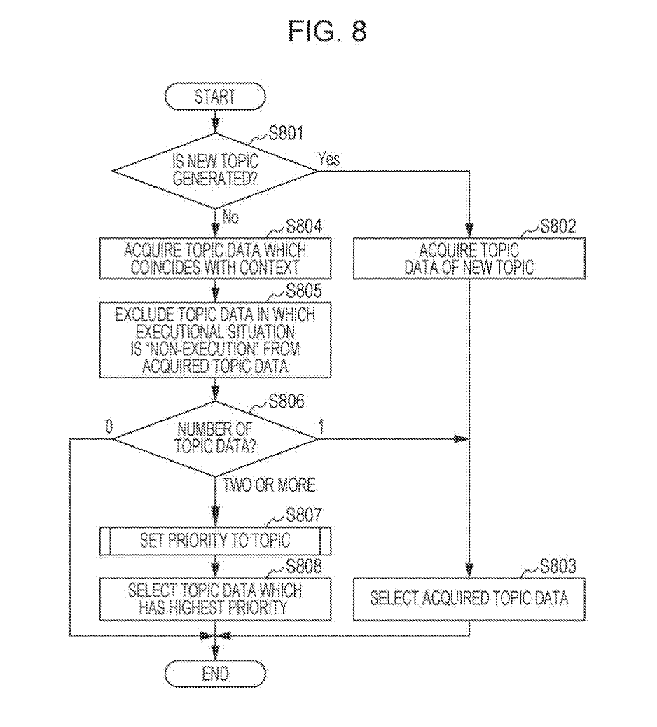

Here, details of the topic selection process (in the case of dialogue) will be described with reference to FIG. 8. FIG. 8 is a flowchart illustrating an example of the topic selection process (in the case of dialogue) according to the first embodiment.

First, the topic selection section 122 determines whether or not the topic data 1000 of the new topic is generated (step S801). That is, the topic selection section 122 determines whether or not the topic data 1000 is generated in the new topic generation process illustrated in FIG. 7. Here, the topic selection section 122 may determine whether or not, for example, the new topic generation flag is “1”.

In step S801, in a case where it is determined that the topic data 1000 of the new topic is generated, the topic selection section 122 acquires the topic data 1000 from the topic DB 210 (step S802).

Subsequently, the topic selection section 122 sets the topic data 1000, which is acquired from the topic DB 210, as the selection topic data 1000 (step S803). That is, the topic selection section 122 stores the topic ID of the topic data 1000, which is acquired from the topic DB 210, in, for example, a prescribed storage area.

Therefore, the topic data 1000 of the new topic is selected by the topic selection section 122. Meanwhile, here, the topic selection section 122 sets, for example, the new topic generation flag to “0”.

In a case where it is determined that the topic data 1000 of the new topic is not generated in step S801, the topic selection section 122 acquires the topic data 1000, which coincides with the context extracted by the analysis section 113, from the topic DB 210 (step S804).

Here, the topic data 1000 which coincides with the context is, for example, the topic data 1000 in which the context, which is extracted by the analysis section 113, is set to a slot corresponding to the context. For example, in a case where the context is “ABC park”, the topic data 1000 which coincides with the context is the topic data 1000 in which the slot indicative of the location is set to “ABC park”. In addition, for example, in a case where the context includes “ABC park” and “Otsu”, the topic data 1000 which coincides with the context is the topic data 1000 in which the slot indicative of the location is set to “ABC park” and the slot indicative of the person is set to “Otsu”.

Meanwhile, in a case where two or more contexts exist, the topic data 1000, in which at least one context is set to a slot corresponding to the context, may coincide with the context. That is, for example, in a case where the contexts “ABC park” and “Otsu” exist, the topic data 1000, in which the slot indicative of the location is set to “ABC park” or the slot indicative of the person is set to “Otsu”, may coincide with the context.

Hereinafter, for convenience, a set of the topic data 1000 acquired from the topic DB 210 in step S801 is expressed as “selection candidate topic data set”.

Subsequently, the topic selection section 122 excludes the topic data 1000, in which the execution situation is “non-execution”, in the topic data 1000 which is acquired from the topic DB 210 (step S805). That is, the topic selection section 122 deletes the topic data 1000, in which the execution situation is “non-execution”, from the selection candidate topic data set.

For example, it is assumed that the topic data 1000-1 in which the execution situation is “ongoing”, the topic data 1000-2 in which the execution situation is “non-execution”, and the topic data 1000-3 in which the execution situation is “ongoing” are acquired in step S804. In this case, the selection candidate topic data set includes the topic data 1000-1, the topic data 1000-2, and the topic data 1000-3.

Here, the topic selection section 122 deletes the topic data 1000-2 in which the execution situation is “non-execution” in the selection candidate topic data set. Therefore, the selection candidate topic data set includes the topic data 1000-1 and the topic data 1000-3.

Subsequently, the topic selection section 122 prescribes the number of topic data 1000 after exclusion is performed in step S805 (step S806). That is, the topic selection section 122 prescribes the number of topic data 1000 included in the selection candidate topic data set in step S805.

In a case where it is prescribed that the number of topic data 1000 is “1” in step S805, the topic selection section 122 performs the process in step S803. That is, the topic selection section 122 sets the topic data 1000, which is included in the selection candidate topic data set, as the selection topic data 1000.

In a case where it is prescribed that the number of topic data 1000 is “0” in step S806, the topic selection section 122 ends the process. In this case, the topic data 1000 is not selected.

In a case where it is prescribed that the number of topic data 1000 is equal to or larger than “2” in step S806, the topic selection section 122 performs a topic priority setting process (step S807). The topic priority setting process is a process of setting priorities with respect to the plurality of topic data 1000 included in the selection candidate topic data set.

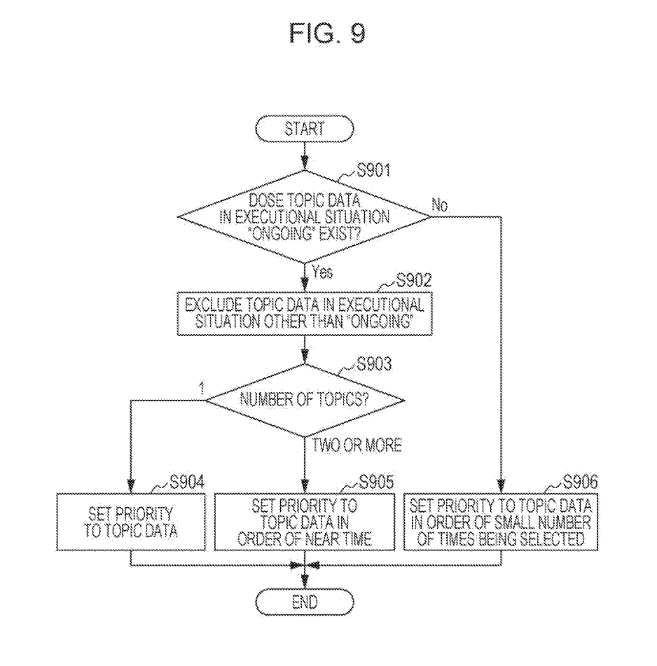

Here, details of the topic priority setting process will be described with reference to FIG. 9. FIG. 9 is a flowchart illustrating an example of the topic priority setting process according to the first embodiment.

First, the topic selection section 122 determines whether or not the topic data 1000, in which the execution situation is “ongoing”, exists (step S901). That is, the topic selection section 122 determines whether or not the topic data 1000, in which the execution situation is “ongoing”, exists in the selection candidate topic data set.

In a case where it is determined that the topic data 1000, in which the execution situation is “ongoing”, exists in step S901, the topic selection section 122 excludes the topic data 1000 other than the topic data 1000 in which the execution situation is “ongoing” (step S902). That is, the topic selection section 122 deletes the topic data 1000 in which the execution situation is not “ongoing” (in other words, the topic data 1000 in which the execution situation is “execution completion”) in the selection candidate topic data set.

Subsequently, the topic selection section 122 prescribes the number of topic data 1000 after exclusion performed in step S902 (step S903). That is, the topic selection section 122 prescribes the number of topic data 1000, which are included in the selection candidate topic data set, in step S902.

In a case where it is prescribed that the number of topic data 1000 is “1” in step S903, the topic selection section 122 sets the priorities to the topic data 1000 (step S904). In this case, the topic selection section 122 may set arbitrary priorities with respect to the topic data 1000 included in the selection candidate topic data set.

In a case where it is prescribed that the number of topic data 1000 is equal to or larger than “2” in step S903, the topic selection section 122 sets the priorities to the topic data 1000 in order of time which is close to a current date and time (step S905).

That is, the topic selection section 122 performs setting such that the priorities of the topic data 1000 included in the selection candidate topic data set become high in order that the time of the topic data 1000 is close to the current date and time. Therefore, it is possible to set a highest priority with respect to a topic of content which is assumed to be executed in the closest future.

Meanwhile, for example, in a case where the time of the topic data 1000 is not set (in a case where the slot indicative of the time is the empty slot), the topic selection section 122 may set, for example, the lowest priority with respect to the topic data 1000. In addition, the topic selection section 122 may set priority according to, for example, a coincidence degree between another slot (the slot indicative of the location, the slot indicative of the person, or the like) and the context which is extracted by the analysis section 113.

In addition, the topic selection section 122 may randomly set the priorities of the topic data 1000 included in the selection candidate topic data set.

In contrast, in a case where it is determined that the topic data 1000, in which the execution situation is “ongoing”, does not exist in step S901, the topic selection section 122 sets the priorities in order that the number of times being selected is small (step S906). That is, the topic selection section 122 performs setting such that the priorities of the topic data 1000 included in the selection candidate topic data set (the topic data 1000 in which the execution situation is “execution completion”) become high in order that the number of times being selected is small. Therefore, it is possible to set the highest priority to a topic which has the smallest number of times being selected (in other words, a topic in which the least dialogue is performed) for topics of the content, the execution of which is completed. Meanwhile, for example, the topic selection section 122 may randomly set the priorities of the topic data 1000.

As described above, the priorities are set with respect to the topic data 1000 included in the selection candidate topic data set.

Returning to FIG. 8. Subsequent to step S807, the topic selection section 122 sets the topic data 1000, to which the highest priority is set, as the selection topic data 1000 in the topic data 1000 included in the selection candidate topic data set (step S808). That is, the topic selection section 122 stores the topic ID of the topic data 1000, to which the highest priority is set, in, for example, the prescribed storage area. In addition, here, the selection topic management section 123 adds “1” to the number of times that the selection topic data 1000 is selected.

As described above, one topic data 1000 (selection topic data 1000) is selected in the topic data 1000 stored in the topic DB 210.

Returning to FIG. 6. Subsequent to step S607, the selection topic management section 123 of the topic management processing section 120 determines whether or not the topic data 1000 is selected by the topic selection section 122 (step S608). That is, the selection topic management section 123 determines whether or not the topic data 1000 is selected by the topic selection section 122 in the topic selection process of step S607.

In a case where it is determined that the topic data 1000 is selected in step S608, the dialogue generation processing section 130 performs an utterance content generation and output process (step S609). The utterance content generation and output process is a process of generating utterance content based on the selection topic data 1000 and outputting the generated utterance content.

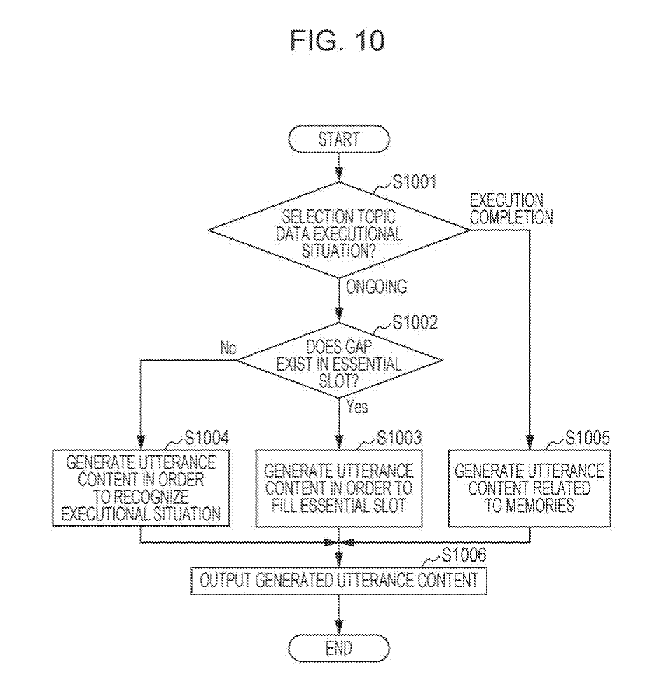

Here, details of the utterance content generation and output process will be described with reference to FIG. 10. FIG. 10 is a flowchart illustrating an example of the utterance content generation and output process according to the first embodiment.

First, the utterance content generation section 131 prescribes the execution situation of the selection topic data 1000 (step S1001).

In a case where the execution situation of the selection topic data 1000 is prescribed as “ongoing” in step S1001, the utterance content generation section 131 determines whether or not an empty indispensable slot of the selection topic data 1000 exists (step S1002).

In a case where it is determined that an empty indispensable slot of the selection topic data 1000 exists in step S1002, the utterance content generation section 131 generates utterance content in order to embed the empty indispensable slot (step S1003).

That is, for example, in a case where an empty indispensable slot of the selection topic data 1000 is the slot indicative of the location, the utterance content generation section 131 generates utterance content which asks a location. The utterance content generation section 131 may generate, for example, “Where are you?” or the like as the utterance content which asks the location, or may generate, for example, “Where can you see it?” or “Where do you buy it?” with reference to a label (“see nemophila”, “buy XX”, or the like). In addition, the utterance content generation section 131 may further generate, for example, “Where will you see nemophila? next month”, “You want to see nemophila with Otsu, right? where will you go to see it?”, and the like with reference to other slots (the slots indicative of the person, the time, and the like).

Similarly, for example, in a case where the empty indispensable slot of the selection topic data 1000 is the slot indicative of the person, the utterance content generation section 131 generates utterance content which asks the person. The utterance content generation section 131 may generate, for example, “Who are you?” or the like as the utterance content which asks the person, or may generate, for example, “Who will you see with?”, “Who will you buy with?”, and the like with reference to a label (“see nemophila”, “buy XX”, or the like”). In addition, the utterance content generation section 131 may further generate, for example, “Who will you go to the ABC park next month?” or the like with reference to other slots (the slots indicative of the location, the time, and the like).

Similarly, for example, in a case where the empty indispensable slot of the selection topic data 1000 is the slot indicative of the time, the utterance content generation section 131 generates utterance content which asks the time. The utterance content generation section 131 may generate, for example, “When is it?” or the like as the utterance content which asks the time, or may generate, for example, “When do you see nemophila”, “When do you buy it?”, or the like with reference to a label (“see nemophila”, “buy XX”, or the like”). In addition, the utterance content generation section 131 may further generate, for example, “When will you see nemophila with Otsu?”, “When will you go to the ABC park?”, or the like, with reference to other slots (the slots indicative of the location, the person, and the like).

As described above, the utterance content generation section 131 generates the utterance content in order to embed the empty indispensable slot for the selection topic data 1000 in which the execution situation is “ongoing” with reference to the labels, slots, or the like of the topic data 1000.

Meanwhile, in a case where a plurality of empty indispensable slots of the selection topic data 1000 exist, the utterance content generation section 131 may generate, for example, utterance content in order to randomly embed any one empty indispensable slot or priorities may be set between indispensable slots in advance.

Subsequently, the utterance content output section 132 outputs utterance content, which is generated by the utterance content generation section 131, by voice (step S1004), Meanwhile, the utterance content output section 132 may display (output), for example, text which expresses the utterance content.

In a case where it is determined that an empty indispensable slot of the selection topic data 1000 does not exist in step S1002, the utterance content generation section 131 generates utterance content in order to recognize the execution situation (step S1005). In other words, the utterance content generation section 131 generates utterance content in order to recognize if execution of content indicated by the selection topic data 1000 is completed.

That is, for example, the utterance content generation section 131 generates, for example, utterance content “did you see nemophila?”, “Did you buy XX?”, or the like in order to recognize the execution situation with reference to the labels (“see nemophila”, “buy XX”, and the like). As described above, the utterance content generation section 131 generates utterance content in order to recognize whether or not the user executes the content of the topic data 1000 for selection topic data 1000 in which the execution situation is “ongoing”. Therefore, in step S1004, the utterance content output section 132 can output the utterance content in order to recognize the execution situation.

In a case where it is prescribed that the execution situation of the selection topic data 1000 is “execution completion” in step S1001, the utterance content generation section 131 generates utterance content related to reminiscences based on the selection topic data 1000 (step S1006).

That is, for example, it is assumed that the label of the selection topic data 1000 is “see nemophila”, the slot indicative of the person is “Otsu”, the slot indicative of the location is “ABC park”, and the slot indicative of the time is “Apr. 9, 2016”. In this case, the utterance content generation section 131 generates, for example, utterance content related to reminiscences “Well, you said that you want to see nemophila in the ABC park with John in April last year”, and the like. As described above, the utterance content generation section 131 generates utterance content related to reminiscences for the selection topic data 1000 in which the execution situation is “execution completion”. Therefore, the utterance content output section 132 can output the utterance content related to reminiscences in step S1004.

As described above, the dialogue system 100 according to the embodiment can perform utterance according to the selection topic data 1000 with respect to the user.

Returning to FIG. 6. In a case where it is determined that the selection topic data 1000 exists in step S604, the selection topic management section 123 of the topic management processing section 120 determines whether or not the selection topic data 1000 is updated (step S610).

That is, for example, it is assumed that the dialogue generation processing section 130 utters utterance content in order to embed the slot indicative of the location of the selection topic data 1000 in the utterance content generation and output process of step S609. Here, the selection topic management section 123 determines whether or not the context, which is extracted from the utterance (answer) of the user with respect to the utterance, includes a location. Furthermore, in a case where it is determined that the extracted context includes the location, the selection topic management section 123 determines that the slot indicative of the location of the selection topic data 1000 is updated.

Similarly, for example, it is assumed that the dialogue generation processing section 130 utters utterance content in order to recognize the execution situation of the selection topic data 1000 in the utterance content generation and output process of step S609. Here, the selection topic management section 123 determines whether or not the context, which is extracted from the utterance (answer) of the user with respect to the utterance, includes terms (for example, “saw already”, “went already”, and the like) which indicate the execution completion. Furthermore, in a case where it is determined that the extracted context includes the terms which indicate the execution completion, the selection topic management section 123 determines that the execution situation is updated in the selection topic data 1000.

In a case where it is determined that the selection topic data 1000 is updated in step S610, the selection topic management section 123 updates the selection topic data 1000 (step S611).

That is, for example, it is assumed that the dialogue generation processing section 130 utters the utterance content in order to embed the slot indicative of the location of the selection topic data 1000 in the utterance content generation and output process of step S609. Here, in a case where the context, which is extracted from the utterance (answer) of the user with respect to the utterance, includes a location “XYZ amusement park”, the selection topic management section 123 sets (updates) the slot indicative of the location of the selection topic data 1000 to “XYZ amusement park”.

Similarly, for example, it is assumed that the dialogue generation processing section 130 utters the utterance content in order to recognize the execution situation of the selection topic data 1000 in the utterance content generation and output process of step S609. Here, in a case where the context, which is extracted from the utterance (answer) of the user with respect to the utterance, includes terms indicative of the execution completion, the selection topic management section 123 updates the execution situation of the selection topic data 1000 to “execution completion”.

As described above, the selection topic data 1000 is updated according to utterance (answer) from the user with respect to the utterance of the dialogue system 100 according to the embodiment.

Meanwhile, in a case where it is determined that the topic data 1000 is not selected in step S608 or it is determined that the selection topic data 1000 is not updated in step S610, the dialogue system 100 ends the process.

As described above, the dialogue system 100 according to the embodiment manages the execution situation of the topic data 1000 corresponding to the intention included in the utterance from the user, and performs utterance in order to embed the indispensable slot (the location, the person, the time, and the like) of the topic data 1000. In addition, the dialogue system 100 according to the embodiment can perform utterance related to the reminiscences of the topic data 1000 in which the execution is completed according to the utterance of the user.

Therefore, the dialogue system 100 according to the embodiment can perform various dialogues (questions on the location, the person, the time, and the like, reminiscences, and the like) for various subjects (topics) by repeatedly performing a dialogue with the user. Therefore, the dialogue system 100 according to the embodiment can continue various dialogues with the user for a long term.

### Second Embodiment

Subsequently, a second embodiment will be described. In the second embodiment, a case where the dialogue system 100 voluntarily performs utterance with respect to the user in a case of an idle talk (that is, a case where dialogue is not performed with the user) will be described. Meanwhile, in the second embodiment, mainly, differences from the first embodiment will be described, and spots in which substantially the same process is performed or spots which have the same functions as in the first embodiment are appropriately omitted.

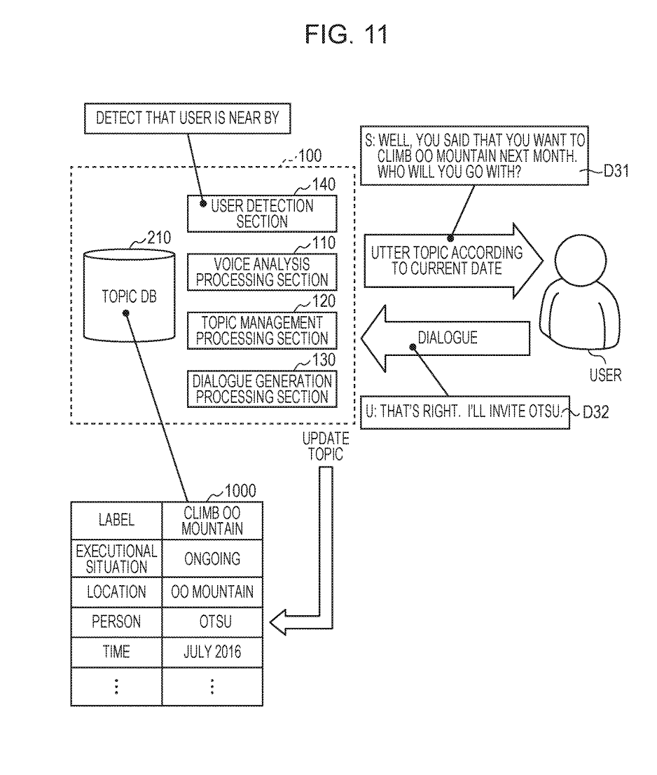

First, utterance performed in the case of the idle talk in a dialogue system 100 according to the embodiment will be described with reference to FIG. 11. FIG. 11 is a diagram illustrating an example of utterance in the case of the idle talk in the dialogue system according to the second embodiment.

As illustrated in FIG. 11, the dialogue system 100 according to the embodiment includes a user detection section 140 that detects that the user is nearby.

As illustrated in FIG. 11, in a case where it is detected that the user is nearby by the user detection section 140, the dialogue system 100 according to the embodiment selects the topic data 1000 according to the current date from the topic DB 210 by the topic management processing section 120. The topic data 1000 according to the current date includes, for example, the topic data 1000 in which the current date is set to the closest future time, the topic data 1000 to which past time corresponding to the current date is set, and the like. Hereinafter, it is assumed that the topic data 1000 in which the current date is set to the closest future time is selected from the topic DB 210.

Furthermore, the dialogue system 100 according to the embodiment utters (outputs) utterance content in order to notify the user of the content of the topic data 1000 with respect to the user by the dialogue generation processing section 130. Thereafter, the dialogue system 100 according to the embodiment updates the topic data 1000 from the answer utterance with respect to the utterance to the user.

That is, the dialogue system 100 according to the embodiment selects, for example, the topic data 1000 in future time which is the closest to the current date (for example, Jun. 10, 2016). Here, in a case where the slot indicative of the person of the topic data 1000 is an empty slot, the dialogue system 100 according to the embodiment generates utterance content “Well, you said that you want to climb XX mountain next month. Who will you go with?”. Furthermore, the dialogue system 100 according to the embodiment performs utterance D31 by outputting the utterance content. Thereafter, for example, in a case where utterance D32 “That's right. I'll invite Otsu.” is provided from the user, the dialogue system 100 according to the embodiment updates the slot indicative of the person of the topic data 1000 to “Otsu”.

As described above, in a case where the user is nearby in the case of the idle talk, the dialogue system 100 according to the embodiment voluntarily utters a topic (subject) according to the current date. Therefore, the dialogue system 100 according to the embodiment can perform a dialogue with the user. In addition, the user can remember the content, which is scheduled to be executed in the close future, by the utterance from the dialogue system 100 according to the embodiment.

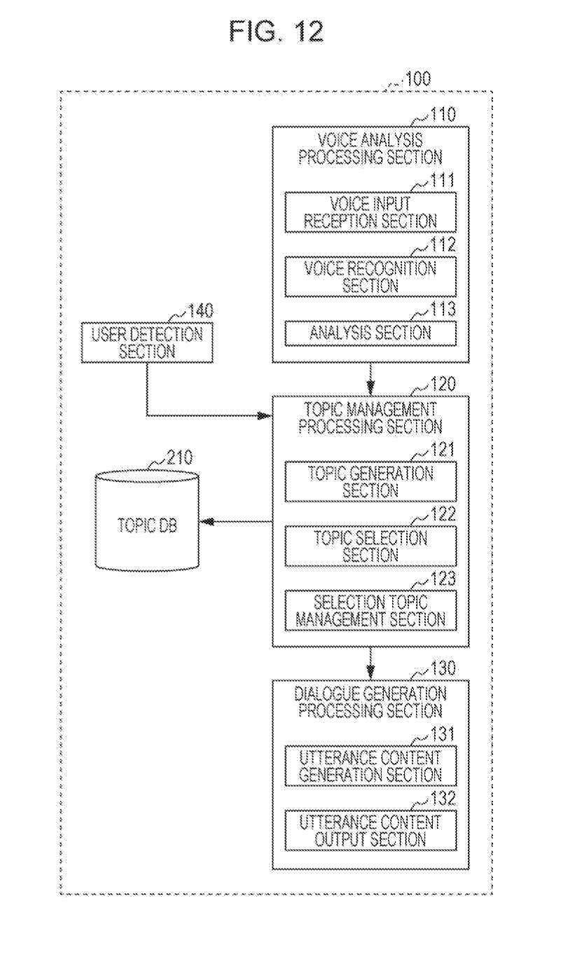

Subsequently, a functional configuration of the dialogue system 100 according to the embodiment will be described with reference to FIG. 12. FIG. 12 is a diagram illustrating an example of the functional configuration of the dialogue system 100 according to the second embodiment.

As illustrated in FIG. 12, the dialogue system 100 according to the embodiment includes the user detection section 140 as described above. The functional section is realized by a process. One or more programs, which are installed in the dialogue system 100, cause the CPU 307 to execute the process.

The user detection section 140 determines whether or not the user is nearby by detecting that the user exists within a prescribed range using, for example, a human motion sensor.

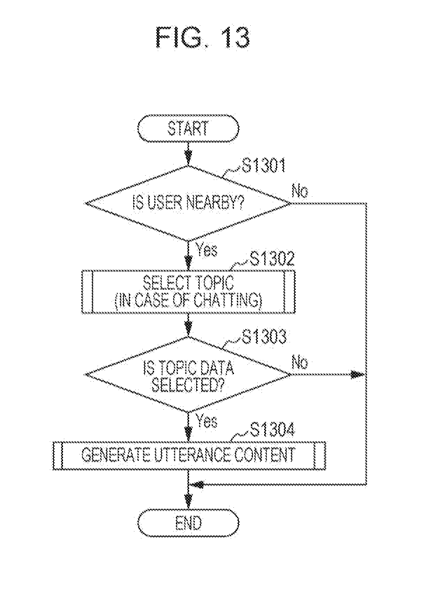

Subsequently, details of a process of the dialogue system 100 according to the embodiment will be described. Hereinafter, an entire process of the dialogue system 100 according to the embodiment in the case of the idle talk will be described with reference to FIG. 13. FIG. 13 is a flowchart illustrating an example of the entire process in the case of the idle talk according to the second embodiment. The entire process in the case of the idle talk illustrated in FIG. 13 is performed, for example, every prescribed hour in the case of the idle talk.

First, the user detection section 140 determines whether or not the user is nearby (step S1301). That is, the user detection section 140 determines whether or not the user is nearby by detecting the user who exists in the prescribed range.

Meanwhile, in the embodiment, whether or not the user is nearby is determined by the user detection section 140. However, the embodiment is not limited thereto. For example, furthermore, whether or not it is a state in which the user can perform dialogue may be determined. The state in which the user can perform dialogue includes, for example, a state in which the user stands up, a state in which a front of the user faces a direction of the dialogue system 100, a state in which the user does not perform any operation or the like, and the like.

In a case where it is determined that the user is not nearby in step S1301, the dialogue system 100 ends the process.

In contrast, it is determined that the user is nearby in step S1301, the topic selection section 122 of the topic management processing section 120 performs a topic selection process (in the case of the idle talk) (step S1302). That is, the topic selection section 122 selects the topic data 1000 according to the current date from the topic data 1000 stored in the topic DB 210.

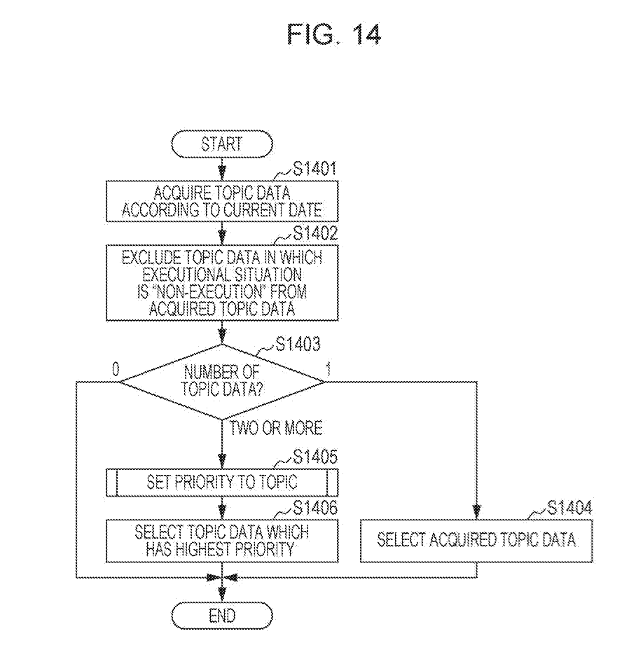

Here, details of the topic selection process (in the case of the idle talk) will be described with reference to FIG. 14. FIG. 14 is a flowchart illustrating an example of the topic selection process (in the case of the idle talk) according to the second embodiment.

First, the topic selection section 122 acquires the topic data 1000 according to the current date from the topic DB 210 (step S1401). That is, the topic selection section 122 acquires, for example, the topic data 1000 in which the current date is set to the closest future time, the topic data 1000 in which the past time corresponding to the current date is set, and the like.

More specifically, for example, it is assumed that the current date is “Apr. 10, 2016. In this case, the topic selection section 122 acquires, for example, topic data 1000 in which time within one month from the current date (that is, “Apr. 11, 2016” to “May 10, 2016”) is set. In addition, the topic selection section 122 acquires, for example, the topic data 1000 in which time before one year from the current date (that is, “Apr. 10, 2015”) and time before and after the current date (that is, “Apr. 9, 2015” and “Apr. 11, 2015”, and the like) is set.

Subsequently, since processes in steps S1402 to S1406 are the same as the processes in steps S805 to S808 of FIG. 8, the description thereof will not be repeated.

As described above, in the topic data 1000 stored in the topic DB 210, the topic data 1000 (selection topic data 1000) according to the current date is selected.

Returning to FIG. 13. Subsequent to step S1302, the selection topic management section 123 determines whether or not the topic data 1000 is selected by the topic selection section 122 (step S1303).

In a case where it is determined that the topic data 1000 is not selected in step S1303, the dialogue system 100 ends the process. In this case, the dialogue system 100 according to the embodiment does not perform utterance.

In contrast, it is determined that the topic data 1000 is selected in step S1303, the dialogue generation processing section 130 performs an utterance content generation and output process (step S1304). Meanwhile, the utterance content generation and output process is the same as in FIG. 10, the description thereof will not be repeated.

Therefore, for example, in a case where the execution situation of the selection topic data 1000 is “ongoing”, the utterance content output section 132 outputs utterance in order to embed the indispensable slot and utterance in order to recognize the execution situation. In addition, for example, in a case where the execution situation of the selection topic data 1000 is “execution completion”, the utterance content output section 132 outputs utterance related to the reminiscences.

As described above, in the case of the idle talk, the dialogue system 100 according to the embodiment can voluntarily perform utterance of the topic data 1000 according to the current date (recognition of the execution situation, question in order to embed the empty slot, reminiscences, and the like) with respect to the user. Therefore, the user can, for example, recognize content which is scheduled to be executed near future or can remember content which is executed in the past.

### Third Embodiment

Subsequently, a third embodiment will be described. In the third embodiment, for example, a case will be described where information, such as news of a picture or a blog, which is prepared by a prescribed application is associated with the topic data 1000 in a case where the execution situation of the topic data 1000 is updated to “execution completion”. That is, in the third embodiment, in a case where the execution situation of the topic data 1000 is updated to “execution completion”, the topic data 1000 is updated using information (for example, uniform resource locator(URL) or the like of the news of the picture or the blog) notified by the prescribed application.

Meanwhile, in the third embodiment, mainly, differences from the first embodiment will be described, and spots in which substantially the same process is performed or spots which have the same functions as in the first embodiment are appropriately omitted.

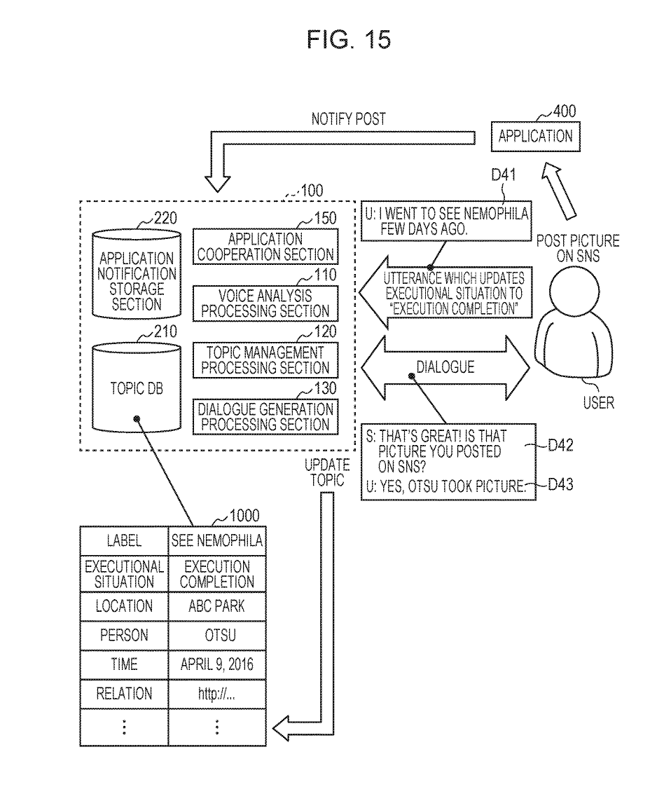

First, a case where the topic data 1000 is updated through notification from an application 400 in the dialogue system 100 according to the embodiment will be described with reference to FIG. 15. FIG. 15 is a diagram illustrating an example of a case where a topic is updated through the notification from the application 400 in the dialogue system 100 according to the third embodiment.

Here, the application 400 includes, for example, various application programs such as an application or a web browser which supplies a social networking service (SNS), a blog post application, a game application, and a map application.

The application 400 may be mounted (installed) on, for example, various pieces of information processing apparatuses, such as a smart phone and a tablet terminal, which are different from the dialogue system 100, or may be mounted on the dialogue system 100. In addition, the application 400 may be, for example, a web application which can be used from a browser mounted on an information processing apparatus which is different from the dialogue system 100 or the dialogue system 100.

Hereinafter, as an example, the application 400 will be described as an application program which can post a picture on the SNS. For example, in a case where the picture is posted, the application 400 notifies the dialogue system 100 of a URL of the picture posted on the SNS. Meanwhile, there is a case where the application 400 is expressed as an “app 400”.

As illustrated in FIG. 15, the dialogue system 100 according to the embodiment includes an application cooperation section 150 that receives a notification from the app 400, and an application notification storage section 220 that stores notification received from the app 400 (hereinafter, expressed as “application notification information”).

As illustrated in FIG. 15, in a case where the user performs utterance D41 in which the execution situation of the selection topic data 1000 is updated to “execution completion”, the execution situation of the selection topic data 1000 is updated to “execution completion” by the topic management processing section 120. Meanwhile, utterance in which the execution situation of the selection topic data 1000 is updated to “execution completion” includes, for example, utterance which indicates completion of an action such as “saw”, “went to see”, “went”, and “have been to”.

In a case where the execution situation of the selection topic data 1000 is updated to “execution completion”, the dialogue system 100 according to the embodiment determines whether or not the application notification information is stored in the application notification storage section 220 by the application cooperation section 150. Furthermore, in a case where the application notification information is stored in the application notification storage section 220, the dialogue system 100 according to the embodiment generates utterance content in order to recognize whether or not the application notification information is related to the selection topic data 1000 by the dialogue generation processing section 130. Thereafter, the dialogue system 100 according to the embodiment utters (outputs) generated utterance content with respect to the user.

In addition, in a case where it is determined that the application notification information is related with the selection topic data 1000 based on the answer utterance with respect to the utterance to the user, the dialogue system 100 according to the embodiment updates the selection topic data 1000.

That is, the dialogue system 100 according to the embodiment performs, for example, utterance D42 by generating utterance content “That's great. Is it a picture you posted on the SNS?” in order to recognize whether or not the application notification information is related to the selection topic data 1000, and outputting the utterance content.

In addition, for example, in a case where answer utterance D42 “Yes. Otsu took the picture.” exists, the dialogue system 100 according to the embodiment determines that the application notification information is related to the selection topic data 1000. Furthermore, the dialogue system 100 according to the embodiment sets a slot indicative of the relation of the selection topic data 1000 to a URL (URL of the picture posted on the SNS) which is indicated by the application notification information.

As described above, in a case where the execution situation of the selection topic data 1000 is “execution completion”, the dialogue system 100 according to the embodiment sets application notification information related to the selection topic data 1000 to the slot indicative of the relation. Therefore, in the dialogue system 100 according to the embodiment, for example, in a case where the utterance content related to reminiscences is generated based on the topic data 1000 in which the execution situation is “execution completion”, it is also possible to provide information which is set to the slot indicative of the relation (for example, URL or the like of the picture) to the user.

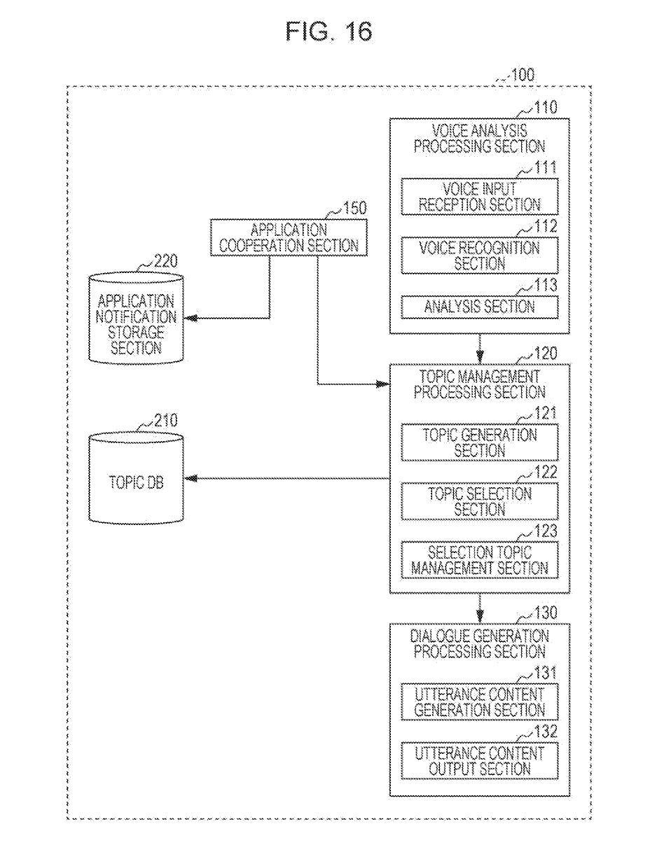

Subsequently, a functional configuration of the dialogue system 100 according to the embodiment will be described with reference to FIG. 16. FIG. 16 is a diagram illustrating an example of the functional configuration of the dialogue system 100 according to the third embodiment.

As illustrated in FIG. 16, the dialogue system 100 according to the embodiment includes the application cooperation section 150 and the application notification storage section 220 as described above. The application cooperation section 150 is realized by a process. One or more programs, which are installed in the dialogue system 100, cause the CPU 307 to execute the process. In addition, the application notification storage section 220 can be realized using, for example, the storage device 308. Meanwhile, the application notification storage section 220 may be realized using the storage device or the like which is connected to, for example, the dialogue system 100 through the network.

The application cooperation section 150 receives the application notification information from the app 400, and stores the application notification information in the application notification storage section 220. The application notification storage section 220 stores the application notification information which is received by the application cooperation section 150.

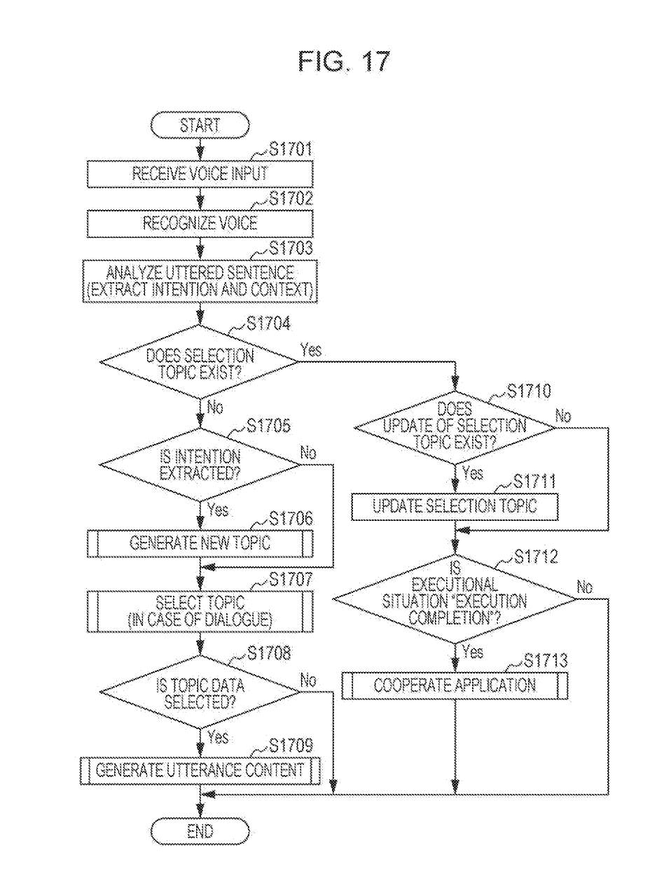

Subsequently, details of an entire process of the dialogue system 100 according to the embodiment will be described. Hereinafter, the entire process of the dialogue system 100 according to the embodiment in a case of dialogue will be described with reference to FIG. 17. FIG. 17 is a flowchart illustrating an example of the entire process in the case of dialogue according to the third embodiment. Meanwhile, since processes in steps S1701 to S1711 of FIG. 17 are the same as the processes in steps S601 to S611 of FIG. 6, the description thereof will not be repeated.

In a case where it is determined that the selection topic data 1000 is not updated in step S1710 or subsequent to step S1711, the selection topic management section 123 determines whether or not the execution situation of the selection topic data 1000 is “execution completion” (step S1712).

In a case where it is determined that the execution situation of the selection topic data 1000 is not “execution completion” in step S1712, the dialogue system 100 ends the process.

In contrast, in a case where it is determined that the execution situation of the selection topic data 1000 is “execution completion” in step S1712, the dialogue system 100 performs an application cooperation process (step S1713). The application cooperation process is a process of setting the application notification information, which is related to the selection topic data 1000 in which the execution situation is “execution completion”, to the slot indicative of the relation of the selection topic data 1000.

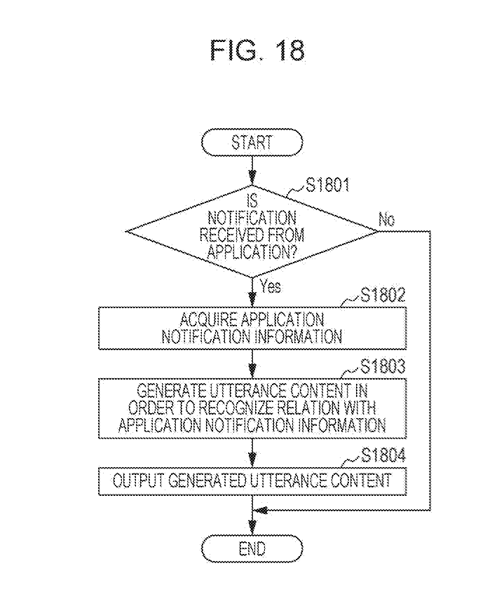

Here, details of the application cooperation process will be described with reference to FIG. 18. FIG. 18 is a flowchart illustrating an example of the application cooperation process according to the third embodiment.

First, the application cooperation section 150 determines whether or not notification is supplied from the app 400 (step S1801). That is, the application cooperation section 150 determines whether or not the application notification information is stored in the application notification storage section 220.

In a case where it is determined that the notification is not supplied from the app 400 in the step S1801, the application cooperation section 150 ends the process.

In contrast, in a case where it is determined that the notification is supplied from the app 400 in step S1801, the application cooperation section 150 acquires the application notification information from the application notification storage section 220 (step S1802). Meanwhile, for example, in a case where a plurality of pieces of application notification information are stored in the application notification storage section 220, the application cooperation section 150 may acquire one piece of application notification information in the plurality of pieces of application notification information.

Subsequently, the utterance content generation section 131 of the dialogue generation processing section 130 generates utterance content in order to recognize whether or not the application notification information, which is acquired by the application cooperation section 150, is related to the selection topic data 1000 (step S1803).

That is, for example, in a case where the application notification information is a URL of the picture which is posted on the SNS, the utterance content generation section 131 generates utterance content “Is it a picture you posted on the SNS?” and the like. The utterance content generation section 131 may generate, for example, utterance content “Is it a picture of the ABC park posted on the SNS?” and the like with reference to the slot indicative of the location of the selection topic data 1000.

In addition, for example, in a case where the application notification information is positional information (for example, positional information indicative of the “ABC park”) which is notified by the app 400 (for example, map application), the utterance content generation section 131 may generate utterance content “Did you go to the ABC park today?” and the like.

As described, the utterance content generation section 131 generates utterance content in order to recognize whether or not the application notification information is related to the selection topic data 1000 in which the execution situation is “execution completion”.

Subsequently, the utterance content output section 132 outputs the utterance content, which is generated by the utterance content generation section 131, by voice (step S1804). Therefore, the dialogue system 100 according to the embodiment can perform utterance in order to recognize whether or not the application notification information is related to the selection topic data 1000.

Thereafter, in a case where the user performs utterance which indicates that the application notification information is related to the selection topic data 1000 as the answer utterance with respect to the utterance, the selection topic management section 123 updates the selection topic data 1000 in step S1711. That is, in this case, the selection topic management section 123 sets the slot indicative of the relation of the selection topic data 1000 to the application notification information (for example, a URL of the picture which is posted on the SNS, positional information of a location which is visited by the user, and the like).

As described above, the slot indicative of the relation of the selection topic data 1000 is set to various pieces of information which are related to the selection topic data 1000. Therefore, in the dialogue system 100 according to the embodiment, for example, in a case where the utterance content related to reminiscences is generated based on the topic data 1000 in which the execution situation is “execution completion”, it is possible to supply information (for example, the URL of the picture, or the like) which is notified by the various app 400 to the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a processor configured to:
extract an intention of a user and context of utterance from the utterance of the user via a microphone,
generate topic data which includes an execution situation of the intention based on the intention and the context,
generate utterance content according to the execution situation of the generated topic data, and
output the utterance content to the user via a speaker.

2. The information processing system according to claim 1, wherein
the intention indicates content, which is desired or scheduled to be performed by the user in the future, or content which is recognized to be desired to perform by the user in the future.

3. The information processing system according to claim 1, further comprising:
a memory configured to store the generated topic data,
wherein the processor is configured to:
acquire the topic data according to the extracted context from the memory in a case where the intention is not extracted from the utterance, and
generate the utterance content according to the execution situation of the acquired topic data.

4. The information processing system according to claim 3,
wherein the processor is configured to acquire the topic data according to a current date from the memory in a case where a dialogue is not performed with the user.

5. An information processing apparatus comprising:
a processor configured to:
extract an intention of a user and context of utterance from the utterance input from the user,
generate topic data which includes an execution situation of the intention based on the extracted intention and the context,
generate utterance content according to the execution situation of the generated topic data, and
output the utterance content to the user.

6. The information processing system according to claim 5, wherein
the intention indicates content, which is desired or scheduled to be performed by the user in the future, or content which is recognized to be desired to perform by the user in the future.

7. The information processing apparatus according to claim 5, further comprising:
a memory configured to store the generated topic data,
wherein the processor is configured to:
acquire the topic data according to the extracted context from the memory in a case where the intention is not extracted from the utterance, and
generate the utterance content according to the execution situation of the acquired topic data.

8. The information processing apparatus according to claim 6,
wherein the processor is configured to acquire the topic data according to a current date from the memory in a case where a dialogue is not performed with the user.

9. A non-transitory, computer-readable recording medium having stored therein a program for causing a computer to execute a process, the process comprising:
extracting an intention of the user and context of utterance from the utterance input from the user,
generating topic data which includes an execution situation of the intention based on the extracted intention and the context,
generating utterance content according to the execution situation of the generated topic data, and
outputting the utterance content to the user.

10. The computer-readable recording medium that stores the program according to claim 9, further comprising:
causing the computer, which includes a memory configured to store the generated topic data, to perform a process of acquiring the topic data according to the extracted context from the memory in a case where the intention is not extracted from the utterance,
wherein the process of generating the utterance content includes generating the utterance content according to the execution situation of the acquired topic data.

11. The computer-readable recording medium that stores the program according to claim 10,
wherein the process of acquiring includes acquiring the topic data according to a current date from the memory in a case where the dialogue is not performed with the user.
